(19) United States
(12) Patent Application Publication
(10) Pub. No.: US 2007/0094630 A1
(43) Pub. Date: Apr. 26, 2007

(54) Power grid design in an integrated circuit

(75) Inventor: Rishi Bhooshan, Uttar. Pradesh (IN)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 11/163,520

(22) Filed: Oct. 21, 2005

(51) Int. Cl. G06F 17/50

(52) U.S. Cl. 716/13

(57) ABSTRACT

An aspect of the present invention computationally determines the metal density of each metal layer supporting a power grid structure providing power to the elements of an integrated circuits. The metal densities are computed such that the power grid would support aggregate power and IR drop constraints. The metal densities thus computed are provided as inputs to a router block, which places the grid structure along with the signal paths on the layout of the eventual integrated circuit sought to be fabricated. Due to the computation of the metal densities upfront and providing to the router block, the iterative design of the IC might be avoided.

### BACKGROUND OF THE INVENTION

1. Field of the Invention

The present invention relates to the design of integrated circuits, and more specifically to a method and apparatus that simplifies power grid design and synthesis in computer aided design (CAD) of an integrated circuit.

2. Related Art

Power grid (power distribution network) generally refers to the conducting paths which connect power supply to each component (e.g., transistor, cell, macro-blocks such as memories and specialized intellectual property, etc.). The power supply in turn is often obtained from VDD (supply voltage)/VSS (ground)tap connections (I/O tap connections) as is well known in the relevant arts.

One general requirement in the design of power grids is that the power be delivered with an acceptable signal strength (e.g., voltage level) to avoid problems such as failure of the components, reduction in speed of operation, etc., as is well known in the relevant arts. The reduction in signal strength when compared to the voltage at VDD/VSS (I/O tap) connections is commonly referred to as IR drop.

One prior approach to the design of power grid entails checking for acceptable IR drop in a verification stage after detailed routing (which is typically performed after placement and global routing), and adding additional conductive material (e.g., copper) on different metal layers if the IR drop is deemed unacceptable to any component.

There are several disadvantages with such an approach. Addition of the conductive material would require revisiting of several stages such as the detailed routing, placement, etc., causing overheads in terms of design time and overall cost.

The problem is of particular concern with increased component density (i.e., number of transistors in unit area) since more components would draw corresponding required power from the same path causing correspondingly higher IR drop. Further, the available metal layers may need to be used minimally for power grid since the metal may be required to route the signals among the large number of components (resulting from high component density).

Accordingly, there is a general need to design power grid more efficiently.

### BRIEF DESCRIPTION OF THE DRAWINGS

The present invention will be described with reference to the accompanying drawings described briefly below.

FIG. 1 is a block diagram of a computer system illustrating an example system in which various aspects of the present invention are implemented.

FIG. 2A depicts the details of an example power grid distribution network (PG network) used to illustrate various aspects of present invention.

FIG. 2B is an example grid structure providing a constant signal (voltage) throughout the integrated circuit.

FIG. 3A depicts bump pattern in a top layer (“bump layer”) that is interposed on the power grid of FIG. 2A in a flip-chip IC.

FIG. 3B illustrates the details of an example grid structure in an area (bump square) of the flip-chip IC.

FIGS. 4A, 4B and 4C together illustrate the manner in which IR drop (within a core ring) can be modeled.

FIG. 5 is a block diagram illustrating the manner in which a power grid is designed according to various aspect of present invention.

FIG. 6 is a flowchart illustrating an approach for the design and synthesis of power grid according to an aspect of the present invention.

FIG. 7 is a circuit diagram of an equivalent model of the circuit of FIG. 4C, and is used to illustrate the manner in which metal density is computed in an embodiment of the present invention.

FIG. 8 is a block diagram illustrating the layout corresponding to a fixed block present in an integrated circuit.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION

1. Overview

An aspect of the present invention computationally determines the metal density of each metal layer supporting a power grid structure providing power to the elements of an integrated circuits. The metal densities are computed such that the power grid would support aggregate power and IR drop constraints.

The metal densities thus computed are provided as inputs to a router block, which places the grid structure along with the signal paths on the layout of the eventual integrated circuit sought to be fabricated. Due to the computation of the metal densities upfront and providing to the router block, the iterative design of the IC might be avoided.

The approaches of above are adapted for design in conjunction with both flip-chip and wire-bond based designs. The approaches also provide for the design of the grid structure even in case fixed blocks such as macro-blocks and sub-chips are contained in the integrated circuit.

Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well known structures or operations are not shown in detail to avoid obscuring the features of the invention.

2. Computer System

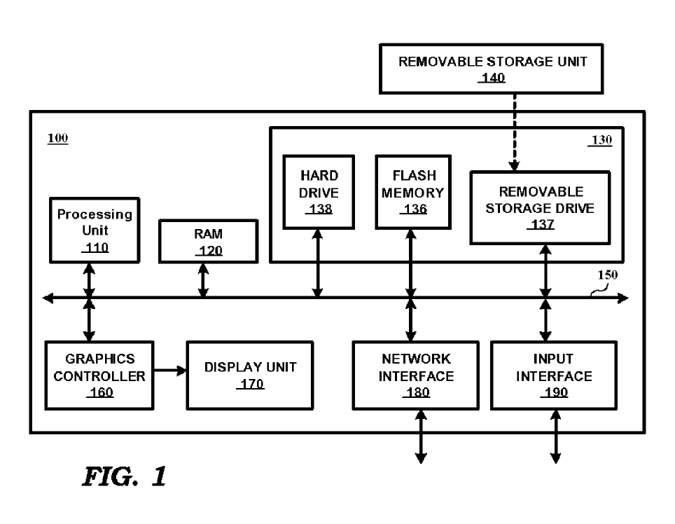

FIG. 1 is a block diagram of computer system 100 illustrating an example system in which various aspects of the present invention are implemented. The system may implement a design tool which facilitates design of power grid according to various aspects of the present invention. While the description is provided with respect to a single system merely for illustration, it should be understood that the features can be implemented using several systems, as would typically be the case in the design of complex integrated circuits. Such computer systems are often networked to distribute the various tasks in the design of a target integrated circuit.

Computer system 100 may contain one or more processors such as central processing unit (CPU) 110, random access memory (RAM) 120, secondary memory 130, graphics controller 160, display unit 170, network interface 180, and input interface 190. All the components except display unit 170 may communicate with each other over communication path 150, which may contain several buses as is well known in the relevant arts. The components of FIG. 1 are described below in further detail.

CPU 110 may execute instructions stored in RAM 120 to provide several features of the present invention (by performing tasks corresponding to various approaches described below). CPU 110 may contain multiple processing units, with each processing unit potentially being designed for a specific task. Alternatively, CPU 110 may contain only a single processing unit. RAM 120 may receive instructions from secondary memory 130 using communication path 150. Data representing the IR drop budget (or permissible IR drop), chip power, power characteristic, etc. (described in sections below), etc., may be stored in and retrieved from secondary memory 130 (and/or RAM 120) during execution of the instructions.

Graphics controller 160 generates display signals (e.g., in RGB format) to display unit 170 based on data/instructions received from CPU 110. Display unit 170 contains a display screen to display the images defined by the display signals. Input interface 190 may correspond to a key-board and/or mouse, and generally enables a user to provide inputs. Network interface 180 enables some of the inputs (and outputs) to be provided on a network. In general, display unit 170, input interface 190 and network interface 180 enable a user to design integrated circuits, possibly from a remote system, according to various aspects of the present invention.

Secondary memory 130 may contain hard drive 131, flash memory 136 and removable storage drive 137. Secondary storage 130 may store the software instructions (which perform the actions described below) and data, which enable computer system 100 to provide several features in accordance with the present invention. Some or all of the data and instructions may be provided on removable storage unit 140, and the data and instructions may be read and provided by removable storage drive 137 to CPU 110. Floppy drive, magnetic tape drive, CD-ROM drive, DVD Drive, Flash memory, removable memory chip (PCMCIA Card, EPROM) are examples of such removable storage drive 137.

Removable storage unit 140 may be implemented using medium and storage format compatible with removable storage drive 137 such that removable storage drive 137 can read the data and instructions. Thus, removable storage unit 140 includes a computer readable storage medium having stored therein computer software and/or data. An embodiment of the present invention is implemented using software running (that is, executing) in computer system 100.

In this document, the term “computer program product” is used to generally refer to removable storage unit 140 or hard disk installed in hard drive 131. These computer program products are means for providing software to computer system 100. As noted above, CPU 110 may retrieve the software instructions, and execute the instructions to provide various features of the present invention described below.

The features of the present invention may be clearer by understanding the details of example power grids, and accordingly the description is continued with respect to an example power grid structure.

3. Power Distribution Network

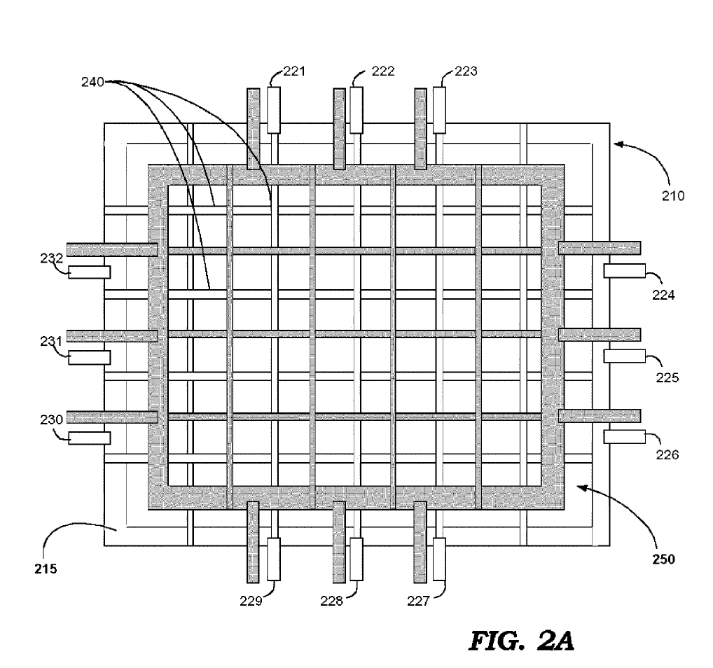

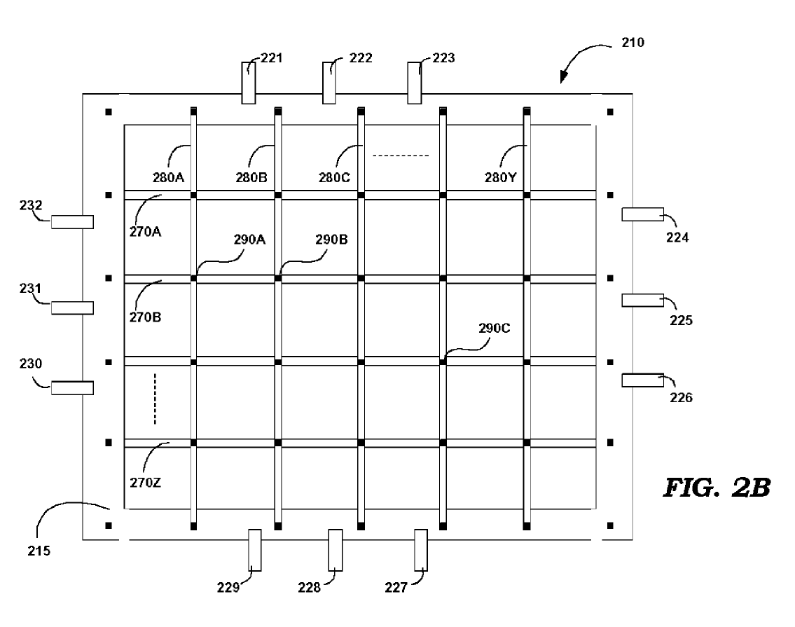

FIG. 2A depicts the details of an example power grid distribution network (PG network) and is later used to illustrate various aspects of present invention. Power grid is shown containing VCC grid 210 (shown in lighter lines), VSS grid 250 (darker lines), and may be contained in a wire-bond integrated circuit (since the power is obtained from the periphery). Each grid is described below in further detail.

VCC grid 210 provides a constant supply voltage VCC (used interchangeably with VDD) to the components of the integrated circuit such as transistors, gates (cells), macro blocks, etc. Similarly, VSS grid 250 provides a reference ground voltage (0 voltage) to the components of the integrated circuit. The structure and operation of only VCC grid is described in detail for conciseness, however similar description is applicable to Vss grid as well.

VCC grid 210 is shown containing VCC core ring 215, I/O tap connections 221-232 and grid structure 240. I/O tap connections 221-232 provide multiple paths/interfaces for receiving the supply voltage VCC from an external power source/element. I/O tap connections 221-232 may be provided in any high level metal layer (e.g., metal layer Q, in case of Q layers), and used for providing supply voltage to core ring 215.

Core ring 215 represents a conducting material at the periphery of the integrated circuit. Core ring 215 maintains a constant voltage VCC at the periphery of the integrated circuit. Core ring 215 may be implemented on multiple metal layers used for providing desired circuit connectivity, and may receive VCC voltage from I/O tap connections 221-232 in the top metal layer.

Grid structure 240 represents the conducting paths providing connectivity to various components of the integrated circuit. Grid structure 240 receives supply voltage VCC from core ring 210 from the periphery of the integrated circuit. Grid structure 240 may contain various conducting metal straps (horizontal and vertical) implemented on a number of metal layers. An example grid structure is illustrated below with reference to FIG. 2B.

FIG. 2B is an example grid structure providing a constant signal (voltage) throughout the integrated circuit. Grid structure 240 is shown containing horizontal conducting paths (horizontal meal straps) 270A-270Z, vertical conducting paths (straps) 280A-280Y and vias 290A-290X. The manner in which the straps are implemented on multiple metal layers is described below.

Generally, horizontal straps 270A-270Z and vertical straps 280A-280Y are implemented on different set of metal layers and connected to each other using vias 290A-290X. Horizontal or vertical straps are uniformly laid with a corresponding pitch and width on each metal layer.

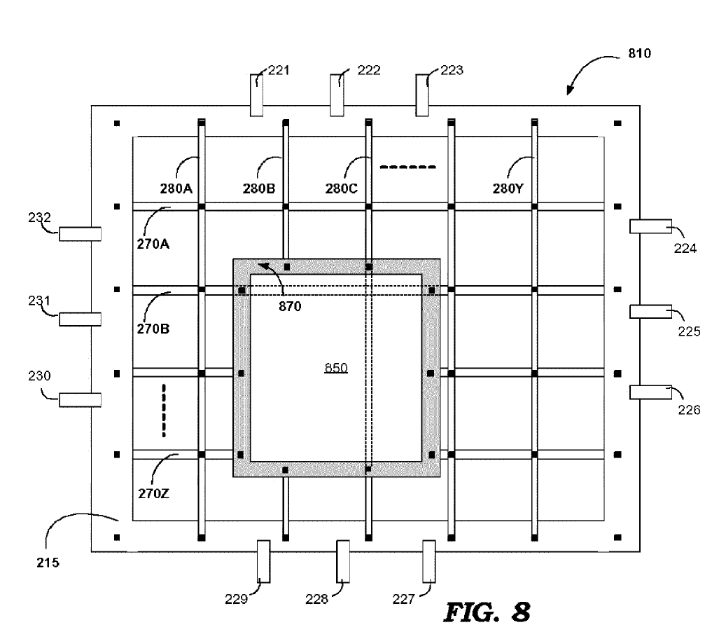

Vias 290A-290X connect horizontal and vertical straps on different layers together. Vias 290A-290X may be implemented using a different conductive material suitable for the purpose. Both ends of each of horizontal straps 270A-270Z and vertical straps 280A-280Y are connected to core ring 215 available on the respective metal layers. However, if fixed blocks such as sub-chips or macro blocks are present in the integrated circuit, the straps in the corresponding metal layers (occupied by fixed blocks) terminate at the ring around the fixed block. The straps may run over the fixed block area in the other metal layers not occupied by the fixed blocks (as represented by the dotted lines in FIG. 8).

Horizontal or vertical metal straps on the first metal layer (M1, metal layer 1) are implemented (width and pitch) according to the size and arrangement of the individual cells (such as logic gates, etc.). The remaining straps are placed on corresponding different metal layers with the corresponding width and pitch values (which can be unequal).

Typically, the IR drop gradually increases from the periphery of the IC towards the center since the I/O tap connections are provided at the periphery of the integrated circuit. Accordingly, the design of the power grid needs to take into consideration the entire area of the integrated circuit.

Various aspects of the present invention generate power grid structure while taking such requirements in wire-bond integrated circuits into consideration. However, some aspects of the present invention are also applicable to flip-chip integrated circuits also, and accordingly the structure and operation of flip-chip integrated circuits is described below next.

4. Flip-Chip Grid Structure

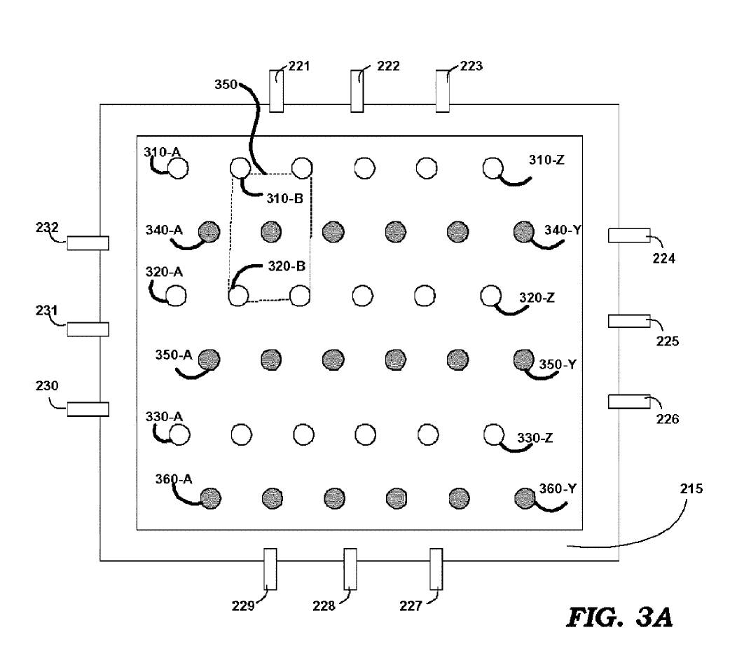

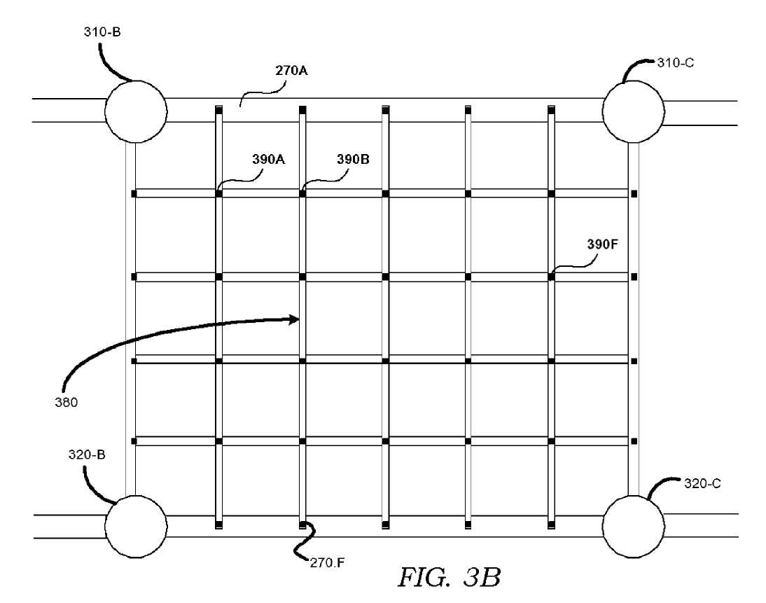

FIG. 3A depicts bump pattern in a top layer (“bump layer”) that is interposed on the power grid of FIG. 2A in a flip-chip IC. The bump pattern (along with core ring 215 and I/O tap connections 221-232) is shown containing VCC I/O tap connections (bumps) 310A-310Z, 320A-320Z and 330A-330Z, and VSS tap connections 340A-340Z, 350A-350Z and 360A-360Z (shown shifted right and in darker color, merely for easy recognition). VCC bumps (e.g., 310A-310Z) make contact with Vcc grid 210 and VSS bumps (e.g., 340A-340Z) make contact with Vss grid 250.

A grid structure is designed for each area (bump square 350, in FIG. 3B) formed by four I/O tap connections, for example, 310B, 310C, 320B, and 320C, and such a grid structure is described below in further detail with respect to FIG. 3B.

FIG. 3B illustrates the details of an example grid structure in area (bump square) 350. Shown there are bumps 310B and 310C making contact with horizontal strap 270A, and bumps 320B and 320C making contact with horizontal strap 270F. The width of straps 270A and 270F (making contact with the bumps) is determined based on the bump size of the fabrication process. Grid structure 380 (i.e., within four bumps) is designed similar to grid structure 250. Logically, several instances of grid structures such as 380 (grid structure within bump square) would be present (repeated) in an IC designed according to flip-chip design.

However, the power flows from top down from highest metal layer to first metal layer (M1). As a result IR drop is minimum on the highest layer and maximum at the lowest metal layer (M1). The total IR drop at any element is the summation of the IR drop on all the metal layers providing power to that element. Thus, the power grid design needs to take into consideration such IR drop voltage across multiple metal layers.

In addition, in an embodiment, the same (design of the) bump square is repeated across the entire area of the integrated circuit, and thus it may be sufficient to design the grid structure for a single bump square. Various aspects of the present invention provide a power grid design while taking into account the considerations noted above. The aspects will be clearer by appreciating the manner in which IR drop occurs (and thus can be modeled), as described below.

5. Modeling IR Drop

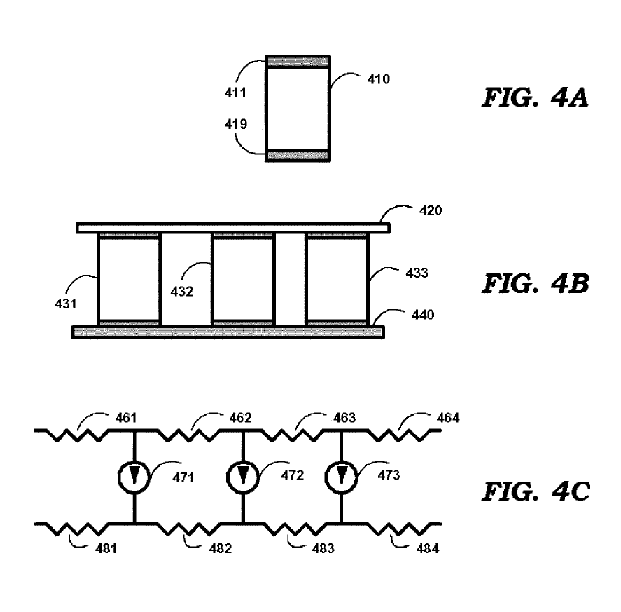

FIGS. 4A, 4B and 4C together illustrate the manner in which IR drop (within a core ring) can be modeled. Broadly, IR drop budget (or maximum permissible IR drop) is provided for entire IC (including interface leads, bond wires, etc., in the package), and the permissible portion of that IR drop in each portion of the path is then budgeted. For illustration, it is assumed that the IR drop budget for the power grid distribution network is computed, and also uniform/equal potential is provided by core ring 215.

Broadly, FIG. 4A depicts the structure of an example cell (such as inverter, etc.), FIG. 4B depicts the array of such cells connected to straps, and FIG. 4C depicts the circuit model corresponding to the cells of FIG. 4B.

With respect to FIG. 4A, cell 410 is shown containing a VCC connect pad 411 and VSS connect pad 419. The distance between VCC connect pad 41 land VSS connect pad 419 equals the height of the cell and forms the pitch of the straps. Similarly, the straps on the lowest metal layer (metal layer 1, M1) making contact with the cells generally needs to be at least as wide as the connect pad for proper connection.

Multiple cells having the same distance between the connect pads are placed in an array and connected to straps as shown in FIG. 4B. Shown there are three cells 431, 432 and 433, VCC strap 420 and VSS strap 440. Accordingly VCC strap 420 provides supply voltage VCC to cells 431-433, and VSS strap 440 provides 0 (ground) voltage VCC to cells 431-433. The manner in which the IR drop due to current flowing in the metal strip (strap 420) reduces the voltage provided to a cell is illustrated below with reference to FIG. 4C.

FIG. 4C is a circuit representing the power distribution to the different cells, and is used to quantify the IR drop in the process. The circuit diagram is shown containing current source 471-473, resistors 461-464 and 481-484. Current sources 471-473 respectively represent the current drawn (power) by cells 431-433. Resistors 461-464 represent effective sheet resistance of the VCC grid between successive VCC connect pads.

Similarly, resistors 481-484 represents sheet resistance of VSS grid between successive VSS connect pads. The electrical circuit thus formed can be analyzed in known ways (using electrical network analysis) to determine the current passing through each resistor, and the IR drop to each cell can then be determined.

The IR drop can be reduced by increasing the metal width (thereby reducing the effective resistance) or adding more metal paths in different metal layers. However, limitations on width and number of metal paths may be imposed, for example, due to the high component density in the IC.

The description is continued with respect to the manner in which an integrated circuit (including the power grid) can be designed according to various aspects of the present invention.

6. Single Pass Power Grid Closure

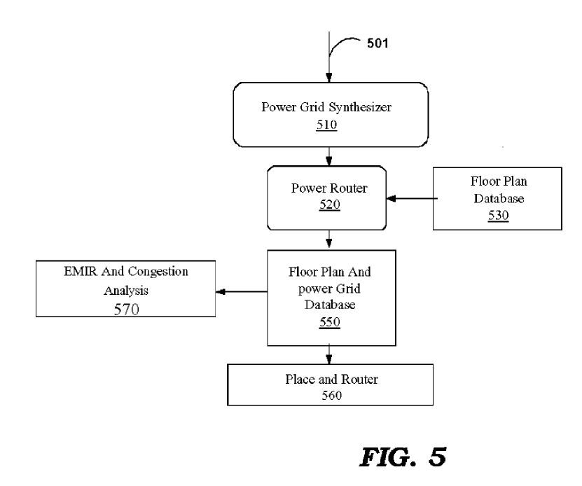

FIG. 5 is a block diagram illustrating the manner in which a power grid is designed according to various aspect of present invention. The block diagram is shown containing power grid synthesizer 510, power router 520, floor plan and power grid database 550, EMIR and congestion analysis 570, floor plan database 530, and place and router 560. Each block is described below in further detail.

Power grid synthesizer 510 designs a power grid according to various aspects of the present invention, and generates data representing characteristics of the designed power grid network. The data (power rules) may be provided on path 512 in any suitable format consistent with the design of power router 520.

Power grid synthesizer 510 receives various constraints and specifications for power grid such as maximum permissible IR drop, chip power (total power that can be consumed by the integrated circuit), constraints with respect to metal layer utilization, etc. The received parameters are used to design the desired power grid (as described in sections below).

Power router 520 receives data representing the characteristics (pitch/gap, width of straps, density) of the power grid on path 512 and a floor plan from floor-plan database on path 532. Power router 520 implements the power grid according to the floor plan received from floor plan database 530, and generates data representing the power grid plan and floor plan. The data is stored in floor plan and power grid database 540.

Place and router 560 receives the floor plan and power grid data from floor plan and power grid database 540 and performs detail routing of signals in the space not occupied by the power grid. EMIR and congestion analysis 570 performs various tests to measure the IR drop (to various elements of interest) and the availability of metal for signal routing. Place and router 560 and power router 520 may together be viewed as a router block routing both the power grid and the signal paths.

In a prior approach, power routing 520 and place and route 560 are performed in multiple iterations to meet various IR drop specifications.

On the other hand, since the power grid is designed upfront to meet the various IR drop and power consumption requirements, the design of ICs in multiple iterations can be avoided, at least for the purpose of power grid design. The manner in which a grid can be designed is illustrated below in further detail.

7. Power Grid Design

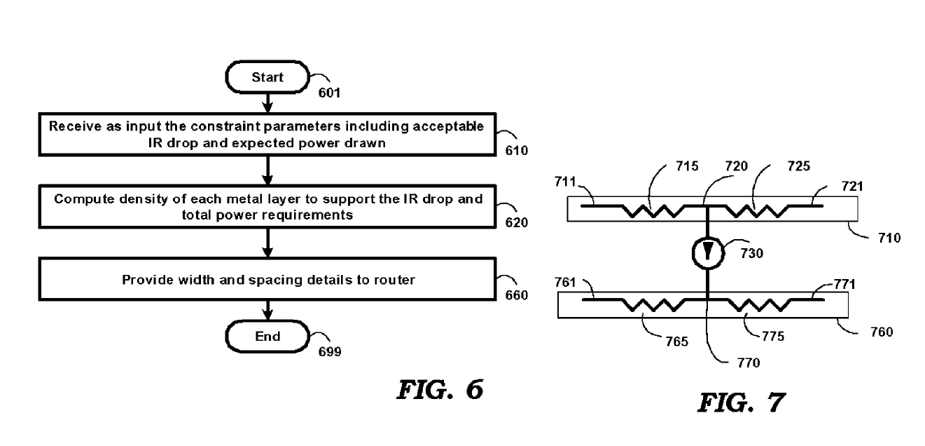

FIG. 6 is a flowchart illustrating an approach for the design and synthesis of power grid according to an aspect of the present invention. The flowchart begins in step 601 and control immediately passes to step 610.

In step 610, power grid synthesizer 510 receives as inputs the constraint parameters including acceptable IR drop and expected total power drawn (by the integrated circuit). Various other design inputs such as number of metal layers, allowable portions of each metal layers usable for the implementation of power grid, presence of any fixed blocks, may also be received. In addition, various technological parameters such as resistivity/conductivity of each metal layer, bump pitch (in case of flip chip technology, etc.) may be received.

In step 620, power grid synthesizer 510 computes the density of each metal layer that would be required to support the IR drop and power consumption requirements. The manner in which the density is computed in an embodiment is described in sections below in further detail.

In step 660, power grid synthesizer 510 provides power grid data representing width and spacing (pitch) details on each metal layer to place and router 560. The data may be provided in a suitable format compatible with any place and route tools used for the purpose. The flow chart ends in step 699.

The manner in which the power grid synthesizer can compute the metal density of each metal layer is illustrated below.

8 Computation of Density of Conductive Material for Wire-Bond IC

FIG. 7 is a circuit diagram of an equivalent model of the circuit of FIG. 4C, and is used to illustrate the manner in which metal density is computed in an embodiment of the present invention. The circuit diagram is shown containing current source 730 (sum of currents of 471-473), VDD power grid 710 and VSS power grid 760. VDD power grid is shown containing resistors 715 and 725 (representing equivalent resistors of respective strap portions connecting to the Vdd core ring) with each resistor assumed to have resistance value equaling RVDD.

Similarly VSS grid is shown containing resistors 765 and 775 with each resistor having a resistance value of RVSS (assuming equality merely for simplicity of analysis). Terminals 711 and 721 (connected to VDD core-ring) receive a supply voltage (ideally equaling a desired voltage level of) VDD and terminals 761 and 771 receive (connected to round core ring) ideal 0 voltage.

Current source 730 is assumed to carry a current It (corresponding current drawn by the cell placed between VDD power grid and VSS power grid). Accordingly, the total current It flows in each of VDD power grid (represented by the combination of resistors 715 and 725) and VSS power grid (represented by the combination of resistors 765 and 775).

Accordingly, the IR drop at point 720 due to the VDD grid or IR drop at point 770 due to the VSS grid (ΔV[VDD/VSS]) is given as:

$$Δ {V}_{[ VDD \vert VSS ]} = \frac{{I}_{t} \times {R}_{[ VDD \vert VSS ]}}{2} \qquad ( 1 )$$

Here factor 2 is due to the fact that the total current coming from both the sides 711 and 721 (assuming equal current, for illustration).

In general, the total IR voltage drop ΔV for an element due to both VDD and VSS grid (power grid (PG) distribution grid network) is the sum of the voltage drop on VDD and VSS grid and is given by:
ΔV=Iₜ×R_{EQ} (2)

wherein R_{EQ} is the equivalent resistance of power grid (PG) distribution network.

With respect to FIG. 7, assuming both R_{VDD} and R_{VSS} are equal to R, the equivalent resistance R_{EQ} will be R for PG (power grid) distribution network containing both VDD grid 710 and VSS 760. If the value of R is just equal to Rₛₕ (sheet resistance of metal layer) then equivalent resistance will be Rₛₕ. The equivalent conductance G for VDD grid 210 will be 2/Rₛₕ and it is the same for VSS grid 260.

The total current Iₜ flowing through the power and ground networks may be represented as Iₜ=Pₜ/V_{DD}. Accordingly, to meet the desired IR drop budget, the equivalent resistance of power grid distribution network may need to be R_{EQ} for a fixed total power consumption of:
Pₜ=V_{DD}Iₜ (3)

Using eq-2, substituting the value of Iₜ in eq-3 then eq-3 becomes

$${P}_{t} = \frac{Δ V \times {V}_{DD}}{{R}_{EQ}} \qquad ( 4 )$$

The conductivity G_{EQ} for the entire metal layers of the power distribution networks may be written as:

$${G}_{EQ} = \frac{1}{{R}_{EQ}} \qquad ( 5 )$$

Substituting R_{EQ} (as inverse of G_{EQ}) from Equation (5) in eq-4:
Pₜ=ΔV×V_{DD}×G_{EQ} (6)

he IR drop ΔV may be represented in terms of absolute number (for example % of VDD, normalized to VDD, etc.). Accordingly, IR drop normalized to VDD may be represented as δ=ΔV/V_{DD}. Equation 6 may be rewritten as:
Pₜ=δ×V_{DD}²×G_{EQ} (7)

Power distribution network may be represented as a resistance network of N metal layers system with current sources (430A-430C) attached at M1 layers between power 710 and ground grids 770. The total power is distributed in all the metal layers used in the power grid distribution networks to meet total IR drop budget. Accordingly, each metal layers may need to meet the same IR drop budget of ΔV.

As noted above with the description of FIG. 4B, the strap width and pitch in M1 is generally fixed, which fixes the metal density for M1. The fixed metal density on M1 can only support a fraction of the total power requirement, while meeting the IR drop. Accordingly, the remaining metal layers need to be designed to support the remaining power requirement, while meeting the IR drop budget (addition of more metal layer increases total metal density, thereby reducing resistivity).

Thus, the power distribution in each metal layer may be represented as follows:
P(N)=δ×V_{DD}²×D(N)×G(N) (8)

herein P(N) represents the power distributed on the N^{th} metal layer (i.e., N can take on values from 1 to Q, Q representing the number of layers), D(N) represents the density of the N^{th} metal layer and G(N) represents the conductivity of N^{th} metal layer. Thus, the total power consumed would be the summation of all distributed power on each metal layer.

Using eq-8, total power Pₜ may be written as:

$${P}_{t} = {\sum }_{N = 1}^{Q} P ( N ) \qquad ( 9 )$$

Substituting P(N) into eq-9:

$${P}_{t} = δ \times {V}_{DD}^{2} \times {\sum }_{N = 1}^{Q} D ( N ) \times G ( N ) \qquad ( 10 )$$

The total power consumption can be controlled by scaling the conductivity (G(N)) of the metal layers. Since conductivity of the higher metal layers is often more than that in the lower metal layers, the higher metal layer can carry more power than lower metal layer for the same metal density.

Conductivity for each metal layers can be scaled with respect to fixed M1 and defined as:
G(N)=g(N)×G (11)

wherein G(N) represents the conductivity of the Nth metal layer, G represents conductivity (fixed, for reasons described above) of the 1^{st} metal layer and g(N) is the ratio of the sheet resistance of the reference layer (M1) to sheet resistance of Nth metal layer and given by:

$$g ( N ) = \frac{{R}_{sh ( M 1 )}}{{R}_{sh ( MN )}} \qquad ( 12 )$$

wherein Rₛₕ(MN) and Rₛₕ(M1) respectively represents the sheet resistance of N^{th} and 1^{st} metal layer.

Conductivity of the first layer may be represented in terms of the sheet resistance and is given as:

$$G = \frac{2}{{R}_{sh ( M 1 )}} \qquad ( 13 )$$

the factor 2 is used to make it as the equivalent conductivity (according to FIG. 7) for both power (VDD) and ground (VSS) networks.

Since metal conductivity is fixed by the technology (fabrication process), it may not be varied to obtain different power distribution on different metal layers. The other parameter D(N) in eq-10 representing the metal density may be varied to control the power distribution on each metal layer as described below.

Typically, lower metal layers are used for signal routing as against higher metal layers. Hence the higher metal layers may be used for power grid distribution networks. The metal density D(N) on the Nth metal layer is defined as:

$$D ( N ) = \frac{{S}_{W ( MN )}}{{M}_{p ( MN )}} \qquad ( 14 )$$

wherein S_{W(MN)} is the strap width of the N^{th} metal layer and M_{p(MN)} is the metal pitch of the same layers. For example, for C035 (0.13 um) technology in one embodiment, the M1 pitch is 3.4 um and width of M1 cell rows straps is 0.75 um then the maximum density D(1) of M1 layers used in power grid network is equal to 0.2205 (22.05%).

However, since M1 cell row power grid elements (straps) are fixed based on the cells used (as per the library cells) for a particular technology, the amount of power that can be distributed on M1 is fixed for a given total IR drop budget. This is due to the fact that the equivalent resistance of straps connecting rows of cells in M1 is fixed.

The rest of the total chip power has to be distributed on higher metal layers to meet the IR drop budget. The manner in which such a distribution can be attained is described below.

A metal density scaling parameter d(N) may be defined as:
D(N)=d(N)×D (15)

wherein D represents the equivalent metal density that is dedicated to power distribution networks on all the metal layers together, and D(N) represents the actual (total) metal density that is dedicated to power routings on the Nth metal layer.

In order to allocate metal utilization to control power distribution in each metal layer as per the design needs, a user may assign a value for d(N) to control the utilization in each metal layer.

Since, the power straps connecting cell rows in M1 (first metal layer) are fixed, the power carried by M1 layer may be calculated using eq-8. From equation 15, d(1) equals 1, since D equals D(N). The power carried by M1 layer may be computed using Equation 14 as:
P(1)=δ×V_{DD}²×D(1)×G(1) (16)

wherein P(1) represents the power distributed over fixed M1 cell rows straps.

The remaining power that needs to be distributed on metal layer M2 to top layer equals the total chip power minus the power distributed over M1 cell rows straps. Such power may be computed using eq-16 and eq-10 as follows:

$${P}_{t} - P ( 1 ) = δ \times {V}_{DD}^{2} \times {\sum }_{N = 2}^{Q} D ( N ) \times G ( N ) \qquad ( 17 )$$

Substituting D(N) and G(N) in eq-17

$${P}_{t} - P ( 1 ) = δ \times {V}_{DD}^{2} \times D \times [ {\sum }_{N = 2}^{Q} d ( N ) \times g ( N ) ] \times G \qquad ( 18 )$$

wherein the summation term of Equation (18) may be represented as:

$$L = {\sum }_{N = 2}^{Q} d ( N ) \times g ( N ) \qquad ( 19 )$$

L may be computed by using g(N) (known from technology) and user defined d(N) (scaling factor, i.e., how much fraction of Nth metal layer can be used for power routing).

Density D may be obtained from Equations 18 and 19 as:

$$D = \frac{{P}_{t} - P ( 1 )}{δ \times {V}_{DD}^{2} \times L \times G} \qquad ( 20 )$$

Power grid synthesizer 510 may compute the width and metal pitch of core power straps for each metal layer (for designing power distribution network) by determining the metal density D(N) of each layer using eq-15. The width or metal pitch can then be calculated using eq-14, user defined d(N) and D from equation 20.

The manner in which the approach described above may be extended to ICs containing fixed blocks such as memories and analog blocks, is described below in further detail.

9. Fixed Blocks

FIG. 8 is a block diagram illustrating the layout corresponding to a fixed block being present in an integrated. Fixed block 850 may represent sub-chip, predefined macro blocks such as third party IP etc. For ease of description/understanding, it is assumed that fixed block 850 is present on VCC grid 210. Accordingly, the horizontal and vertical straps are shown terminating at fixed ring 870.

In general, fixed blocks are implemented using predefined portions of different metal layers. As a result, the corresponding portions of metal layers are generally not made available for use in implementing power distribution network. Often, the fixed blocks use lower metal layers thereby preventing (blocking) power routing in lower metal layers and may allow power routing in higher metal layers.

For illustration, it is assumed that m(N) represents the percentage of chip area that is prevented (blocked) by fixed blocks. Accordingly, the metal density may be scaled (increased) to meet the required total IR drop budget. The power distribution on metal layers (fixed metal layers) used for the fixed block is given as.
P_{M}(N)=δ×V_{DD}²×m(N)×D_{M}(N)×G(N) (21)

wherein D_{M}(N) represents the effective metal density for each metal layer used by fixed blocks. The parameter D_{M}(N) may be computed as:

$${D}_{M} ( N ) = \frac{{M}_{F} ( N )}{{A}_{F}} \qquad ( 22 )$$

wherein M_{F}(N) represents the total metal area of each metal layer inside fixed blocks and A_{F} represents the total area of fixed blocks. The power distributed in the core metal layers (area remaining after placing the fixed blocks) may be computed as:
P_{C}(N)=δ×V_{DD}²×D_{C}(N)×[1−m(N)]×G(N) (23)

wherein D_{C}(N) represents the metal density in the core area outside fixed blocks that need to be calculated for calculating metal width and pitch for core straps in the core area. The total power distribution for each metal layer is summation of power distributed on fixed metal layers inside fixed blocks and power distributed on rest of available core area. The total power P(N) may represented as:
P(N)=P_{C}(N)+P_{M}(N) (24)

wherein P_{C}(N) represents the power distributed on metal layer in core area and P_{M}(N) represents the power distributed on fixed metal layers in fixed blocks. By substituting P_{C}(N) and P_{M}(N) in Equation 24 D_{C}(N) may be computed as:

$${D}_{C} ( N ) = \frac{D ( N ) - m ( N ) \times {D}_{M} ( N )}{1 - m ( N )} \qquad ( 25 )$$

The pitch and width may be computed using D_{C}(N) and fixing one of the values as:

$${D}_{C} ( N ) = \frac{{S}_{W ( MN )}}{{M}_{p ( MN )}} \qquad ( 26 )$$

Using above equations power grid synthesizer 510 may compute and design power distribution networks for designs with fixed blocks.

The description is continued with respect to the manner in which the width of core ring 215 (providing/ maintaining constant power supply to the power distribution network) may be determined.

10. Core Ring/Fixed Ring

Power straps (power distribution network) are terminated at core ring or fixed ring, as can be appreciated from FIG. 8. The core ring 215 provides the total power through PG network for the entire IC (integrated circuit) and fixed ring 870 provides power for fixed block 850. The core ring may be optimized by computing the width of the core ring that is needed to supply the total core power and the number of metal layers needed to implement such width.

Assuming there is uniform power distribution along the chip, core ring 215 ensures that the total power is supplied from all sides of the chip. For example, electro-migration current thresholds on each metal layer ring may require a corresponding width of the core ring. Hence, the width of the core ring is given as:

$${W}_{C} = \frac{2 \times {P}_{C} \times 1000}{{N}_{VDD} \times {V}_{DD} \times {J}_{AVG}} \qquad ( 27 )$$

wherein W_{c} represents the width of the core rings in μm, J_{avg} (mA/um) represents the EM current limit for a particular metal layer, V_{dd} is the core voltage, NVDD represents the number of power pad cells placed in the IO ring and PC represents total core power.

The width of the core I/O ring also need to satisfy other constraints such as permissible IR drop budget of 10 ring periphery required to make equi-potential core ring. The width requirement based on such a consideration may be computed as:

$${W}_{c} = \frac{I \times L}{{δ}_{CR} \times {V}_{dd} \times Sum ( G )} \qquad ( 28 )$$

wherein I represents current supplied by one power pad (computed as total power/number of VDD/VSS pads), L represents distance between two successive VDD/VSS pads, Summation (G) represents the summation of the conductivities of each metal layers on which core rings are implemented and δ_{CR} represents permissible IR drop budget of IO ring set to be considered as a equi-potential core ring.

Thus the higher value of Wc from Equations 27 and 28 may be chosen for the width of the core ring.

If the chosen core ring width W_{c} is more than the maximum allowed width of a particular metal layer, the total calculated core ring width may be broken up into multiple of each allowed metal width according to equation 29 and the number of core rings is given as:

$${N}_{c} = \frac{{W}_{c}}{{W}_{m}} \qquad ( 29 )$$

wherein W_{c} is the calculated core ring width using eq-28 for a particular metal layer and Wₘ is allowed width of a particular metal layers as per the technology (fabrication process).

Equations 30A and 3B given below may be used to respectively compute width of macro block ring and sub-chip rings as:

$$\begin{matrix}{W}_{M ( macro )} = \frac{{P}_{M ( macro )} \times 1000}{n \times {V}_{dd} \times {J}_{avg}} & ( 30 A ) \\ {W}_{sc} = \frac{{P}_{s} \times 1000}{n \times {V}_{dd} \times {J}_{avg}} & ( 30 B )\end{matrix}$$

wherein, W_{sc} represents the sub-chip core ring width, Pₛ represents the sub-chip/fixed block power, W_{M}(macro) represents required width of macro rings that is required to supply the macro block power and to meet the EM limit, n represents the number of power ports of fixed block and P_{M} (macro) represents the total macro block power.

The required with of IO tap connections required to meet the EM current limit is given by:

$${W}_{Tap ( IO )} = \frac{{P}_{f ( IO cell )} \times 1000}{{V}_{dd} \times {J}_{avg}} \qquad ( 31 )$$

wherein W_{Tap(IO)} is the required width to meet the EM current limit and P_{f (IO cell)} represents the power carried by each I/O tap connections.

While the description of above is substantially provided with respect to wire-bond based ICs for illustration, it should be appreciated that several features can be implemented with respect to flip-chip based ICs as well. Some example differences in equations are described below for illustration.

11. Computations for Flip-chip IC.

For simplicity of analysis it is assumed that Pₜ represents the total power supplied to the IC from all the bumps together. Hence, the power in each bump square may be represented as total power/total number of bump squares (Pₜ/N_{bumps}). Since each bump square contain 5 power sources (4 VDD and 1 ground), the power supplied by each bump (each source) P_{BSQ} may be represented as:

$${P}_{BSQ} = \frac{{P}_{t}}{5 \times {N}_{Bump}} \qquad ( 32 )$$

wherein N_{bumps} may be computed as:

$${N}_{Bump} = \frac{X}{{B}_{p}} \times \frac{Y}{{B}_{p}} \qquad ( 33 )$$

wherein X and Y are the length and width dimension of the integrated circuit, B_{P} the bump pitch of the same net (VDD or VSS).

Generally, the IR drop in flip chip design is additive in nature with minimum IR drop at the highest metal layer and maximum at the lowest metal layer. The total IR voltage drop is the summation of IR drop in each metal layers carrying total power. Hence the IR voltage drop in each metal layers using eq-13 can be written as:

$$δ ( N ) = \frac{P ( N )}{{V}_{DD}^{2} \times D ( N ) \times G ( N )} \qquad ( 34 )$$

The total IR drop will be summation of IR drop in each metal layer and given by:

$$δ = \frac{{P}_{BSQ}}{{V}_{DD}^{2}} \times [ {\sum }_{N = 1}^{Q} \frac{1}{D ( N ) \times G ( N )} ] \qquad ( 35 )$$

Using eq-9 and eq-10, eq-17 can be written as:

$$δ = \frac{{P}_{BSQ}}{{V}_{DD}^{2} \times D \times G} [ {\sum }_{N = 1}^{Q} \frac{1}{d ( N ) \times g ( N )} ] \qquad ( 36 )$$

Since M1 cell rows power straps are fixed by the cells size, the effective metal density D is calculated without considering metal layer M1.

Also, since bump layer (at the top) is the ideal voltage straps whose width is decided based on the bump size, the design of PG networks is performed only up to Q-1 metal layers. Hence summation in equation 17 and 18 is performed for value N==2 to (Q-1), wherein Q represents the total number of layers in the flip-chip design, and may be represented as:

$${K}_{2} = {\sum }_{K = 2}^{Q - 1} \frac{1}{d ( N ) \times g ( N )} \qquad ( 37 )$$

Substituting K₂, D₂ may be calculated using eq-18 as below

$${D}_{2} = \frac{{P}_{BSQ} \times {K}_{2}}{δ \times {V}_{DD}^{2} \times G} \qquad ( 38 )$$

wherein D₂ is the effective metal density without M1 layers.

Now d(1) is computed for a fixed density D(1) (on M1) using below equation:

$$d ( 1 ) = \frac{D ( 1 )}{{D}_{2}} \qquad ( 39 )$$

from d(1), the effective K and D for the Nth metal layers system may be computed as:

$$\begin{matrix}K = {\sum }_{N = 1}^{Q - 1} \frac{1}{d ( N ) \times g ( N )} & ( 40 ) \\ D = \frac{{P}_{BSQ} \times K}{δ \times {V}_{DD}^{2} \times G} & ( 41 )\end{matrix}$$

From computed D metal density D(N) of each layers may be computed using eq-15 and width or pitch using eq-14 by fixing one of them.

Using this mathematical analytical model, power grid synthesizer 510 may calculate width and metal pitch of core power straps for each metal layers for designing PG networks in flip chip design as well.

12. Region Based Power Grid Optimization

It should be further appreciated that the equations of above can be adapted for portions (viewed as an IC in the above equations) of an integrated circuit having different requirements than the rest of the integrated circuit. For example, in case of flip chip designs, if there are different regions/blocks of different power consumptions then we can customize power grid for such regions/blocks by considering the power and area of each region in equations 32 and 33 to meet the total IR drop budget.

On the other hand, in the case of wire bond design, if different areas consume different amounts of power within the integrated circuit, then power grid networks may be optimized with high/less density corresponding to such regions of different power consumptions. For example, assuming a region R of high power consumption P_{R,}, the corresponding high density may be computed first by considering IR drop budget of the region and then considering the corresponding region as a fixed block to determine the overall grid network.

With reference to the equations above, if δ_{R} is the IR drop budget of a region (treated as a fixed block) of high power consumption then δ_{R} may be given as:

$${δ}_{R} = \frac{{P}_{R}}{{P}_{t}} \times δ \qquad ( 42 )$$

wherein, Pₜ and δ_{R} respectively represents the total power consumption and total IR drop budget of the chip respectively.

Using eq-42 the power grid may be customized for each region consuming different amount/magnitude of power.

### 13. CONCLUSION

While various embodiments of the present invention have been described above, it should be understood that they have been presented by way of example only, and not limitation. Thus, the breadth and scope of the present invention should not be limited by any of the above described exemplary embodiments, but should be defined only in accordance with the following claims and their equivalents.

What is claimed is:

1. A method of designing an integrated circuit containing a plurality of components connected by a plurality of signal paths, a core ring and a grid structure in a plurality of metal layers, said core ring receiving a supply voltage Vdd, wherein said grid structure couples said core ring to said plurality of components, said method comprising:
receiving data representing a total power that can be consumed by said integrated circuit during operation and a permissible voltage drop in relation to said supply voltage to said plurality of components;
determining computationally a corresponding metal density of each of said plurality of metal layers for said grid structure by using said total power and said permissible voltage drop requirements as inputs; and
providing said metal densities as an input to a router block which places said plurality of components, said core ring and said grid structure, and routes said plurality of signal paths,
whereby said grid structure is implemented with said set of metal layers which together provide at least said metal density.

2. The method of claim 1, wherein said router block is not used iteratively for meeting said total power and said permissible voltage drop requirements due to said determining prior to said providing.

3. The method of claim 1, wherein said grid structure comprises a plurality of straps, wherein said corresponding metal density comprises a pitch and a width of each of said plurality of straps, wherein said pitch represents a distance between each pair of said plurality of straps.

4. The method of claim 3, wherein said determining also determines a core width of said core ring to meet said total power requirement, equi-potential requirement within a desired threshold, and electro-migration (EM) requirement of said core ring.

5. The method of claim 4, wherein said core width (Wc) of said core ring is computed as equaling the larger value computed according to the below two equations:
$${W}_{C} = \frac{2 \times {P}_{C} \times 1000}{{N}_{VDD} \times {V}_{DD} \times {J}_{AVG}}$$
wherein P_{C} represents total core power, N_{VDD} represents the number of power pad cells placed in the IO ring, V_{DD} represents supply voltage, and J_{avg} represents a desired limit of electro-migration current,
$${W}_{c} = \frac{I \times L}{{δ}_{CR} \times {V}_{dd} \times \sum ( G ( N ) )}$$
wherein I represents current supplied by a power pad (computed as total power/number of VDD/VSS pads), L represents distance between two successive VDD pads, Σ(G(N)) represents the summation of the conductivities of each metal layer on which core rings are implemented and δ_{CR} represents permissible IR drop budget of IO ring set to be considered as a equi-potential core ring.

6. The method of claim 5, wherein said determining determines a second set of metal layers using which said core width of said core ring can be attained, and also a corresponding width of each of said second set of metal layers.

7. The method of claim 6, wherein corresponding density D[N] of each of said plurality of layers is computed according to:
D(N)=d(N)×D
wherein d[N] represents a control parameter determining a percentage of metal which can be used on Nth metal layer for said power grid, and D is given by:
$$D = \frac{{P}_{t} - P ( 1 )}{δ \times {V}_{DD}^{2} \times L \times G}$$
wherein Pt represents said total power, P(1) represents the power distributed on metal layer 1, δ
represents a normalized IR drop computed from said permissible IR drop, G represents a conductivity of said metal layer 1, and L represents a scaling factor given by:
$$L = {\sum }_{N = 2}^{Q} d ( N ) \times g ( N )$$
wherein g(N) represents a conductivity ratio of Nth metal layer in relation to said G.

8. The method of claim 7, wherein said G is computed according to:
$$G = \frac{2}{{R}_{sh ( M 1 )}}$$
wherein R_{sh(M1)} represents a sheet resistance of metal layer 1.

9. The method of claim 4, wherein said plurality of components comprise a fixed block occupying a fixed area on said integrated circuit, wherein said grid structure comprises a ring providing said Vcc to said fixed block, wherein said determining determines said corresponding metal densities of each of said plurality of metal layers after excluding said fixed area from the area of a third set of metal layers which are used by said fixed block.

10. The method of claim 9, wherein said determining determines a width of said ring to meet a total power requirement and a electro-migration (EM) requirement of said fixed block.

11. The method of claim 10, wherein said fixed block comprises one of a sub-chip and a macro-block.

12. The method of claim 9, wherein said determining determines the metal density Dc[N] of the Nth metal layer according to:
$${D}_{C} ( N ) = \frac{D ( N ) - m ( N ) \times {D}_{M} ( N )}{1 - m ( N )}$$
wherein m[N] represents said fixed area in the form of a fraction of total area in the Nth metal layer, D_{M}(N) represents the effective metal density for each metal layer used by fixed blocks and D(N) represents the metal density on N^{th} metal layer.

13. The method of claim 12, wherein power is provided in said integrated circuit according to a wire-bond design.

14. The method of claim 6, further comprising a bump layer on top of said plurality of metal layers, said bump layer providing a plurality of bumps according to a flip-chip design, with each of said plurality of bumps coupling said supply voltage Vdd to said grid structure, wherein said plurality of bumps are placed uniformly in an area covered by said bump layer.

15. The method of claim 14, where a second plurality of bumps are provided in said bump layer, said second plurality of bumps coupling ground voltage to a second grid structure.

16. The method of claim 14, wherein corresponding density D[N] of each of said plurality of layers is computed according to:
D(N)=d(N)×D
wherein d[N] represents a control parameter determining a percentage of metal which can be used on Nth metal layer for said power grid, and D is given by:
$$D = \frac{{P}_{BSQ} \times K}{δ \times {V}_{DD}^{2} \times G}$$
wherein, G represents a conductivity of said metal layer 1, δ represents a total IR drop in said plurality of metal layers, P_{BSQ} computed as:
$${P}_{BSQ} = \frac{{P}_{t}}{5 \times {N}_{Bump}}$$
and K is computed as
$$K = {\sum }_{N = 1}^{Q - 1} \frac{1}{d ( N ) \times g ( N )}$$
wherein, Pₜ represents said total power, g(N) represents a conductivity ratio of Nth metal layer in relation to said G and N_{bumps} represented as:
$${N}_{Bump} = \frac{X}{{B}_{p}} \times \frac{Y}{{B}_{p}}$$
wherein X and Y respectively represents the length and width dimension of the integrated circuit, Bₚ represents the pitch of said plurality of bumps.

17. The method of claim 16, wherein said G is computed according to:
$$G = \frac{2}{{R}_{sh ( M 1 )}}$$
wherein R_{sh(M1)} represents a sheet resistance of metal layer 1.

18. A computer readable medium carrying one or more sequences of instructions to facilitate a designer to design an integrated circuit using a digital processing system, said integrated circuit containing a plurality of components connected by a plurality of signal paths, a core ring and a grid structure in a plurality of metal layers, said core ring receiving a supply voltage Vdd, wherein said grid structure couples said core ring to said plurality of components, wherein execution of said one or more sequences of instructions by one or more processors contained in said digital processing system causes said one or more processors to perform the actions of:
receiving data representing a total power that can be consumed by said integrated circuit during operation and a permissible voltage drop in relation to said supply voltage to said plurality of components;
determining computationally a corresponding metal density of each of said plurality of metal layers for said grid structure by using said total power and said permissible voltage drop requirements as inputs; and
providing said metal densities as an input to a router block which places said plurality of components, said core ring and said grid structure, and routes said plurality of signal paths,
whereby said grid structure is implemented with said set of metal layers which together provide at least said metal density.
